(19) United States
(12) Patent Application Publication
(10) Pub. No.: US 2025/0023704 A1
(43) Pub. Date: Jan. 16, 2025

(54) MULTI-LINK OPERATION AND INDICATION FOR NEXT GENERATION WIRELESS LOCAL AREA NETWORKS

(71) Applicant: Newracom, Inc., Irvine, CA (US)

(72) Inventors: Yujin Noh, Irvine, CA (US); Heejung Yu, Daejeon (KR); Jong-ee Oh, Irvine, CA (US); Jaeyoung Ryu, Irvine, CA (US)

(73) Assignee: Newracom, Inc., Irvine, CA (US)

(21) Appl. No.: 18/903,733

(22) Filed: Oct. 1, 2024

Related U.S. Application Data
(63) Continuation of application No. 17/450,895, filed on Oct. 14, 2021.
(60) Provisional application No. 63/105,687, filed on Oct. 26, 2020.
(60) Provisional application No. 63/091,584, filed on Oct. 14, 2020.

(51) Int. Cl. H04L 5/14; H04L 5/00

(52) U.S. Cl. CPC H04L 5/14; H04L 5/0092

(57) ABSTRACT

A method provides for reducing interlink interference between an access point (AP) multi-link device (MLD) having a simultaneous transmit and receive (STR) link set and a non-AP MLD with a non-STR link set. The method includes transmitting data, by the AP MLD, to the non-AP MLD on a first link, simultaneously receiving data, by the AP MLD from the non-AP MLD, on a second link, and aligning, by the AP MLD, an end time of transmitted physical layer protocol data units (PPDUs) using padding in response to concurrently transmitting another PPDU, by the non-AP MLD, on a link that is part of the non-STR link set.

### CROSS-REFERENCE TO RELATED APPLICATIONS

This application is a Continuation of pending U.S. application Ser. No. 17/450,895, titled “MULTI-LINK OPERATION AND INDICATION FOR NEXT GENERATION WIRELESS LOCAL AREA NETWORKS”, which claims the benefit of U.S. Provisional Application No. 63/105,687, filed Oct. 26, 2020, titled, “MULTI-LINK OPERATION TO SOLVE BLINDNESS AND HIDDEN NODE PROBLEM,” and U.S. Provisional Application No. 63/091,584, filed Oct. 14, 2020, titled, “DYNAMIC MULTI-LINK OPERATION AND INDICATION FOR NEXT GENERATION WIRELESS LANS,” each of which are hereby incorporated by reference.

### TECHNICAL FIELD

The present disclosure generally relates to wireless communications, and more specifically, relates to improving multi-link operations in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

When an AP multi-link device (MLD) with a simultaneous transmit and receive (STR) link set and a non-AP MLD with a non-STR link set send and receive data simultaneously on two different links, interlink interference may occur. This interlink interference may reduce the link and channel utilization efficiency and thereby degrade communication performance.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a dual sub-carrier modulation technique, in accordance with some embodiments of the present disclosure.

FIG. 9 is a diagram showing multi-link devices and links between the multi-link devices, in accordance with some embodiments of the present disclosure.

FIG. 10 is a diagram showing out-of-band emission interference of asynchronous multi-link operations, in accordance with some embodiments of the present disclosure.

FIG. 11 is a diagram showing synchronous and asynchronous multi-link operations, in accordance with some embodiments of the present disclosure.

FIG. 12 is a diagram showing synchronous multi-link operations using padding, in accordance with some embodiments of the present disclosure.

FIG. 13 is a diagram showing dynamic multi-link operations, in accordance with some embodiments of the present disclosure.

FIG. 14 is a diagram showing an uplink/downlink switching case for dynamic multi-link operations, in accordance with some embodiments of the present disclosure.

FIG. 15 shows a table of puncturing mode indication, in accordance with some embodiments of the present disclosure.

FIG. 16 is a diagram showing transmission of EHT-SIG including puncturing pattern, in accordance with some embodiments of the present disclosure.

FIG. 17 is a diagram showing an example of transmission/reception (TX/RX) switching transmission in dynamic multi-link operations, in accordance with some embodiments of the present disclosure.

FIG. 18 is a diagram showing another example of TX/RX switching transmission in dynamic multi-link operations, in accordance with some embodiments of the present disclosure.

FIG. 19 is a diagram showing static multi-link operation (MLO), in accordance with some embodiments of the present disclosure.

FIG. 20 is a diagram showing dynamic MLO, in accordance with some embodiments of the present disclosure.

FIG. 21 is a diagram showing link allocation for multi-link operations, in accordance with some embodiments of the present disclosure.

FIG. 22 is a diagram showing a management frame for static multi-link operation, in accordance with some embodiments of the present disclosure.

FIG. 23 is a diagram showing a wireless network environment in which a hidden node problem may occur, in accordance with some embodiments of the present disclosure.

FIG. 24 is a diagram showing a blindness problem in the form of a packet transmission/reception flowchart, in accordance with some embodiments of the present disclosure.

FIG. 25 is a diagram showing a case of encountering a combination of both the blindness problem and the hidden node problem, in accordance with some embodiments of the present disclosure.

FIG. 26 is a diagram showing a block acknowledgement transmission method using padding, in accordance with some embodiments of the present disclosure.

FIG. 27 is a diagram showing a link protection signaling method wherein interframe space between block acknowledgement and link protection may be a short interframe spacing, in accordance with some embodiments of the present disclosure.

FIG. 28 is a diagram showing a transmission priority indication method, in accordance with some embodiments of the present disclosure.

FIG. 29 is a diagram showing a subchannel signaling method, in accordance with some embodiments of the present disclosure.

FIG. 30 is a diagram showing a method of transmitting normal request to send/clear to send (RTS/CTS) and long range RTS/CTS using multi-links, in accordance with some embodiments of the present disclosure.

FIG. 31 is a diagram showing a wireless network environment with different signaling ranges, in accordance with some embodiments of the present disclosure.

FIG. 32 is a diagram showing a trigger frame format, in accordance with some embodiments of the present disclosure.

FIG. 33 is a diagram showing a common info field format, in accordance with some embodiments of the present disclosure.

FIG. 34 is a diagram showing a user info field format, in accordance with some embodiments of the present disclosure.

FIG. 35 shows another user info field format, in accordance with some embodiments of the present disclosure.

FIG. 36 is a diagram showing an aggregated trigger frame, in accordance with some embodiments of the present disclosure.

FIG. 37 is a table showing trigger type subfield encoding, in accordance with some embodiments of the present disclosure.

FIG. 38 is a diagram showing a single trigger frame, in accordance with some embodiments of the present disclosure.

FIG. 39 is a diagram showing two options for the single trigger frame, in accordance with some embodiments of the present disclosure.

FIG. 40 is a diagram showing a trigger frame with AID 4095, in accordance with some embodiments of the present disclosure.

FIG. 41 is a diagram showing a method for supporting simultaneous transmit-receive in a wireless network, in accordance with some embodiment of the present disclosure.

### DETAILED DESCRIPTION

The present disclosure generally relates to wireless communications, and more specifically, relates to improving multi-link operations in a wireless network.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

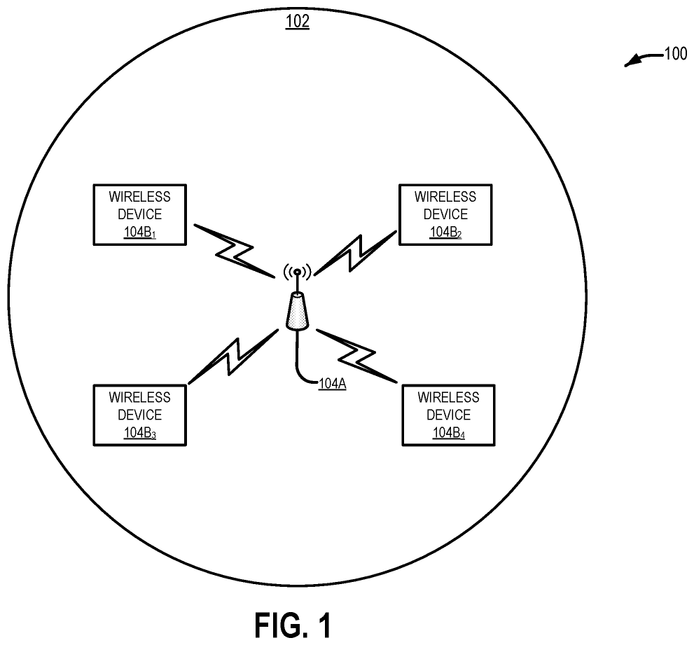

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs. Although shown with four non-AP STAs (e.g., the wireless devices 104B1-104B4), the WLAN 100 may include any number of non-AP STAs (e.g., one or more wireless devices 104B).

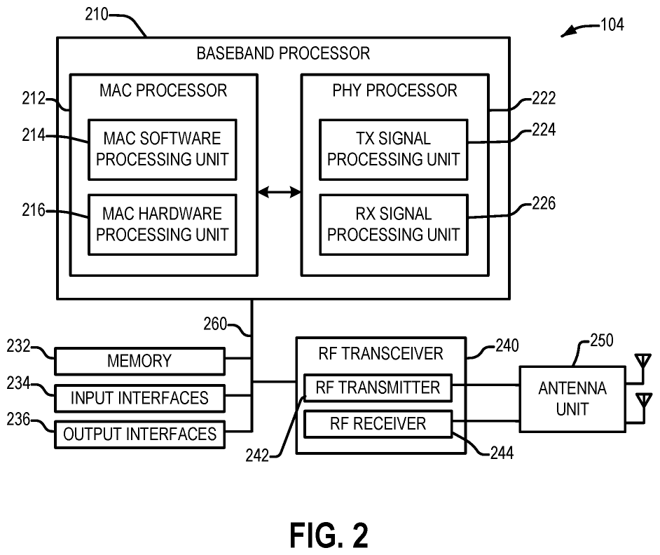

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

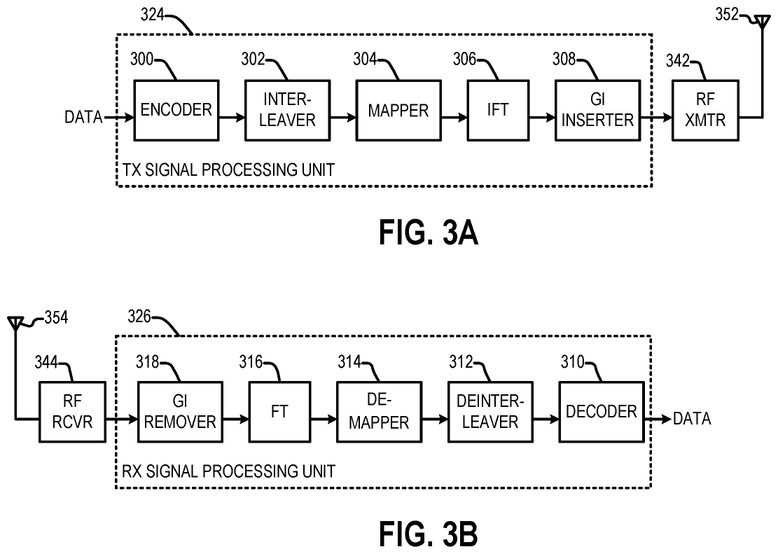

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHZ), 20 MHz, 40 MHZ, 80 MHZ, 160 MHZ, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

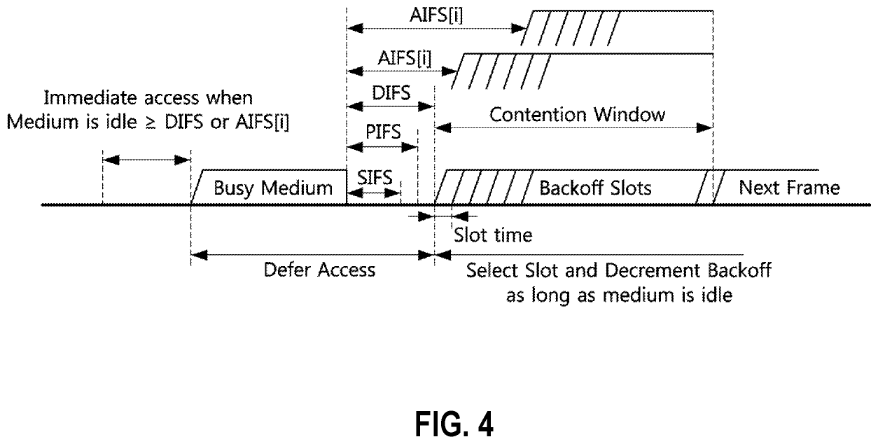

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QoS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

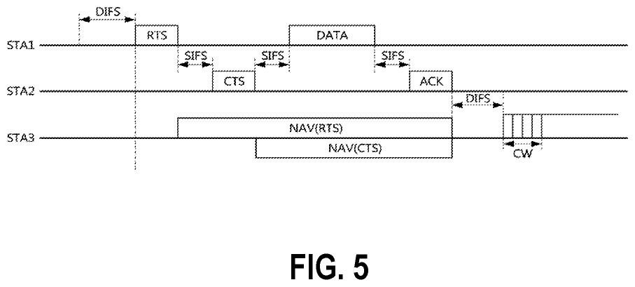

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period clapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

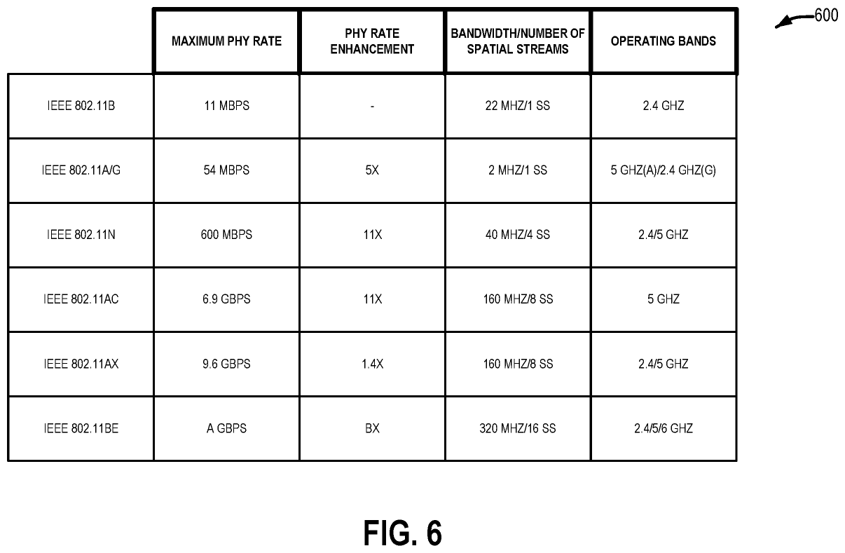

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHZ) could be considered to increase the maximum PHY rate. For example, 320 MHz or 160+160 MHz data could be transmitted in the 6 GHz band. For example, 160+160 MHz data could be transmitted across the 5 and 6 GHz bands.

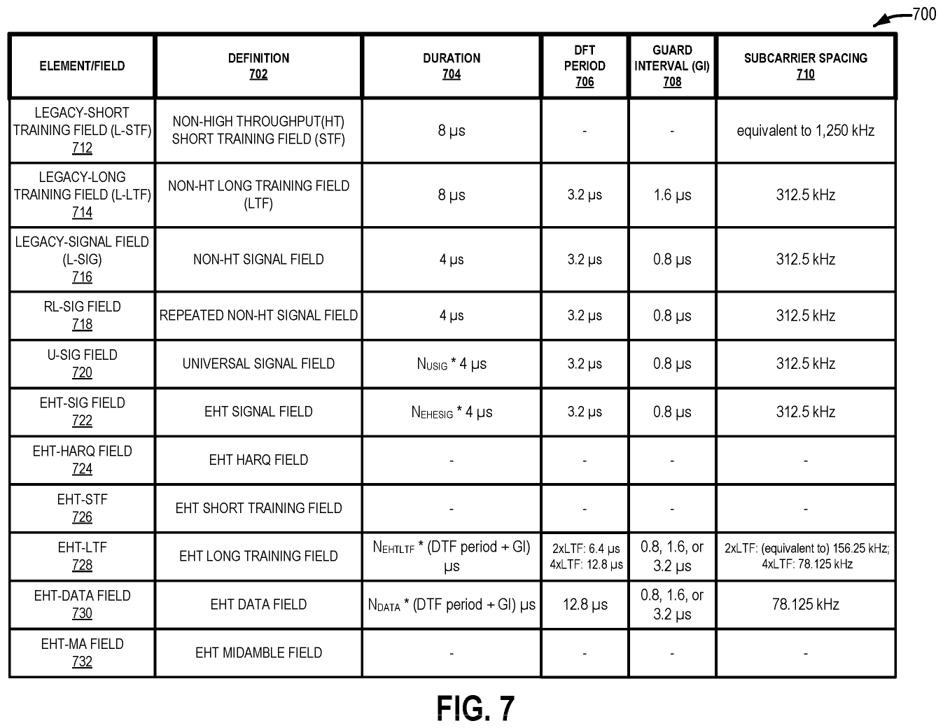

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

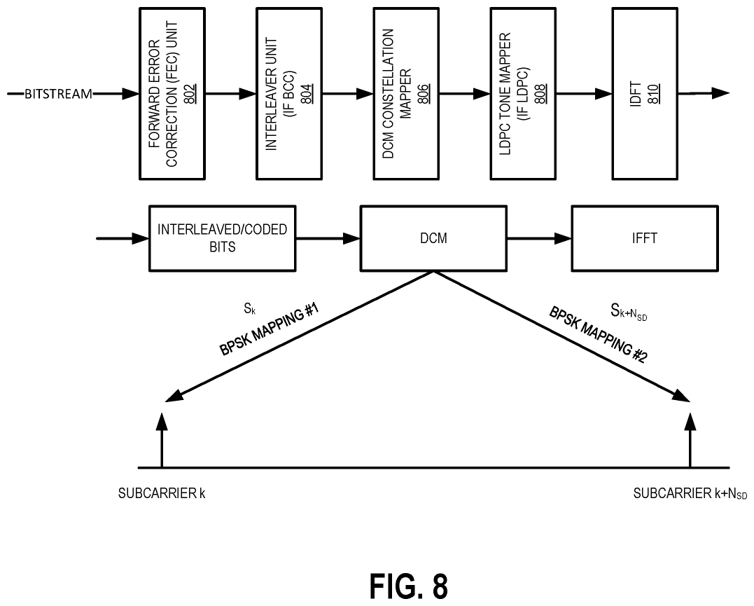

In order to increase the coverage especially for data portion, a DCM (Dual Carrier Modulation) could be considered to achieve at least 3 dB lower sensitivity level for longer coverage as shown in FIG. 8.

As shown in FIG. 8, a signal/bitstream is processed by a forward error correction (FEC) unit 802 and the resulting coded bits are interleaved by an interleaver unit 804 when binary convolutional coding (BCC) is utilized. Thereafter, the interleaved/error-corrected/coded bits are processed by a dual sub-carrier modulation (DCM) constellation mapper 806, a low-density parity-check (LDPC) tone mapper 808 (if LDPC is utilized), and an inverse DFT (IDFT) 810.

In FIG. 8, Sk and Sk+NSp are modulated symbols for data tone k and k+Nsp in a DCM feature where Sk and Sk+NSp are both binary phase shift keying (BPSK) modulated and NSD is defined as half of Nsp in a non-DCM PPDU. To reduce a peak-to-average power ratio (PAPR) for a modulation and coding scheme (MCS) 0 in a DCM modulation, half of the modulated symbols are scrambled with

$${S}_{k + {N}_{S D}} = {S}_{k} {e}^{j π ( k + {N}_{S D} )} .$$

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HAPQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP coordination has been discussed as a possible technology to be adopted in IEEE 802.11be, where there is high level classification depending on various AP coordination schemes. For example, there is a first type of technique in which data for a user is sent from a single AP (sometimes referred to as “coordinated”) or there is a second type of technique in which data for a user is sent from multiple APs (sometimes referred to as “joint”).

For the coordinated AP technique, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. As for a joint AP technique, multiple APs are transmitting jointly to a given user.

As mentioned above, when an AP multi-link device (MLD) with a simultaneous transmit and receive (STR) link set and a non-AP MLD with a non-STR link set send and receive data simultaneously on two different links, interlink interference may occur. This interlink interference may reduce the link and channel utilization efficiency and thereby degrade communication performance.

An approach is described herein to solve uplink/downlink interference problems between multiple links when data is transmitted in one link while data is being transmitted in another link simultaneously to improve throughput and latency using a multi-link function.

According to some embodiments, when two multi-link devices that transmit using two different links that are non-STR link sets, the management frame and/or control frame is used to dynamically adjust the guard band and simultaneously perform uplink/downlink asynchronous transmission.

An embodiment is a method by a first wireless device in a wireless network to support simultaneous transmit-receive with a second wireless device in the wireless network using a first wireless link and a second wireless link. The method includes transmitting multilink operation information to the second wireless device, wherein the multilink operation information indicates a frequency separation that is to be maintained between the first wireless link and the second wireless link and transmitting a first frame to the second wireless device using the first wireless link while simultaneously receiving a second frame from the second wireless device using the second wireless link, wherein the frequency separation is maintained between the first wireless link and the second wireless link when transmitting the first frame and receiving the second frame simultaneously.

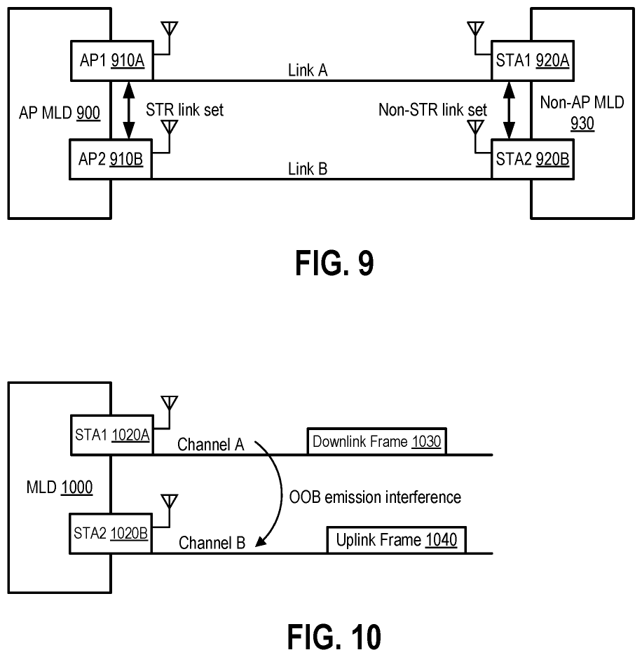

FIG. 9 is a diagram showing multi-link devices and links between the multi-link devices, in accordance with some embodiments of the present disclosure. As shown in FIG. 9, a multi-link device (MLD) (e.g., AP MLD 900 and non-AP MLD 930) may transmit data by accessing channels through multiple links (e.g., wireless link A and wireless link B-referred to herein simply as “link A” and “link B”). AP MLD 900 and non-AP MLD 930 may have components that operate independently for simultaneous data transmission and reception through link A and link B, which are on different channels. AP MLD 900 may implement AP1 910A and AP2 910B, which are capable of independent data transmission and reception on separate links. Non-AP MLD 930 may implement STA 920A and STA2 920B, which are capable of independent data transmission and reception on separate links.

A single MLD may have multiple physical wireless interfaces but have a single MAC address and IP address, and a single interface (MAC SAP) on the logical link control (LLC) layer. Each link and upper layers may operate by being connected through MAC SAP. A MLD may usc multiple links to independently or jointly perform fragmentation and aggregation of packets, dynamic link switching, and retransmission.

MLDs may simultaneously transmit and receive data using different channels in the same frequency band. For example, three different frequency channels can be used to transmit and receive data simultaneously in the 5 GHz band. MLDs may also transmit and receive data simultaneously using different frequency bands. For example, it is possible to simultaneously transmit and receive data in the 2.4 GHz, 5 GHZ, and 6 GHz bands.

Asynchronous and synchronous multi-link modes have the effect of improving throughput and latency. In general, considering the medium occupied regardless of other links an asynchronous multi-link mode has better performance and efficiency than a synchronous multi-link mode. However, for an asynchronous multi-link mode, the TX (transmission) of one link may cause an interference problem to the RX (reception) of other links if the isolation between the two links is insufficient. An MLD operating a multi-link with an intolerable interference effect on transmission and reception between links is referred to as a non-STR link set MLD. A MLD operating a multi-link that is able to transmit and receive simultaneously using different links is referred to as a STR link set MLD.

Since the frequency separation between different frequency bands in a non-STR link set MLD is large, interference due to power leakage between the links of a MLD using different bands on a multi-link may be small. However, when the links are in the same band, the circuit and antenna in the MLD are located close by and can cause interference due to out-of-band (OOB) emission as shown in FIG. 10. FIG. 10 is a diagram showing out-of-band emission interference of asynchronous multi-link operations, in accordance with some embodiments of the present disclosure. In the example shown in FIG. 10, from the perspective of the receiving end (STA2 1020B of the non-STR link set MLD), the OOB signal transmitted from STA1 1020A (downlink frame 1030), which is the transmitting end within the non-STR link set MLD, originates from a transmitter location adjacent to the receiver. The uplink frame 1040, which is the desired signal, originates from a transmitter location distant from the receiver. Thus, the OOB signal is highly likely to be received at a higher power than the uplink frame 1040 even if the OOB power is significantly reduced with a transmission spectral mask. The effect of interference due to power leakage between links is greater as channels used by the MLD become closer. Thus, the performance deterioration of simultaneous transmission and reception may become more serious.

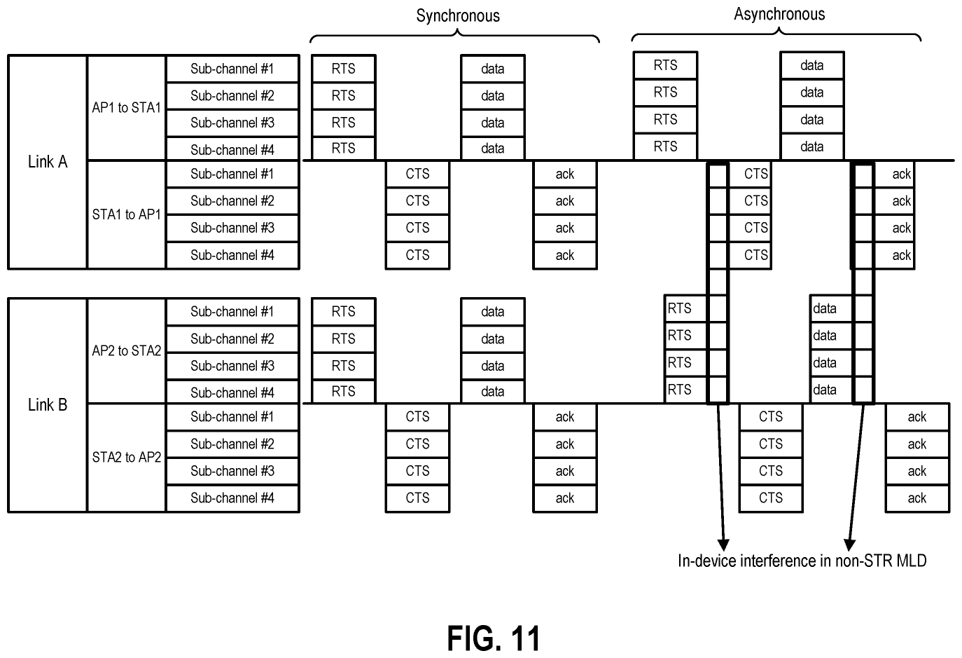

FIG. 11 is a diagram showing synchronous and asynchronous multi-link operations, in accordance with some embodiments of the present disclosure. FIG. 11 illustrates a case where via links A and B, AP1 and AP2 as AP MLD and STA1 and STA2 as non-AP MLD synchronously or asynchronously transmit and receive RTS/CTS and data/acknowledgement through sub-channels 1, 2, 3, and 4, wherein RTS/CTS could be RTS, MU-RTS Trigger, or CTS frame in a non-HT duplicated PPDU. There is no problem in the synchronous transmission and reception between link A and link B, but as shown in the Figure, in the asynchronous transmission and reception, performance deterioration may occur duc to in-device interference if uplink and downlink transmissions are progressed at the same time (e.g., partially overlapped) in the non-STR link sct.

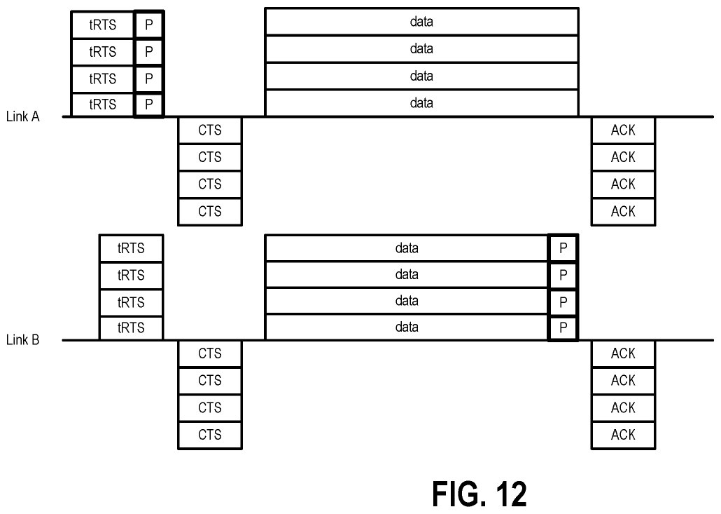

FIG. 12 is a diagram showing synchronous multi-link operations using padding, in accordance with some embodiments of the present disclosure. The Figure illustrates a case of performing synchronous transmission by attaching padding to a triggering type request to send RTS (hereinafter referred to as tRTS) or data in order to enable synchronous transmission in a non-STR MLD. In the Figure, “P” indicates padding to enable synchronous transmission. An advantage of this padding approach is that it only requires padding to achieve synchronous transmission. However, the efficiency of link use and power efficiency may be reduced because the PPDU length for data transmission of link B may need to be determined at the time of tRTS transmission in link A and the padding may need to be applied to achieve synchronous transmission.

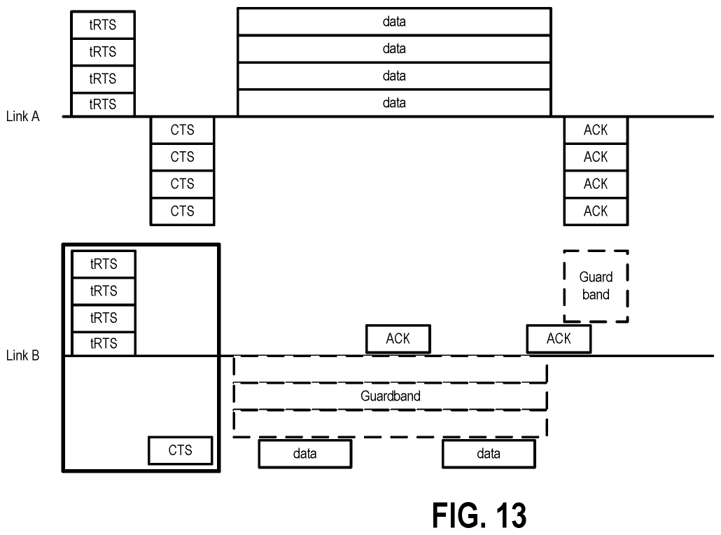

FIG. 13 is a diagram showing dynamic multi-link operations, in accordance with some embodiments of the present disclosure. As shown in the Figure, when tRTS is transmitted before sending data in link A, IRTS is also transmitted in link B simultaneously. The duplicated IRTS in Link B may include guard band information and NAV (network allocation vector) information of link A. For example, NAV of the tRTS may be set to the time of transmitting CTS, data, and an acknowledgement (ACK); three subchannels are assigned to a guard band and may be indicated through tRTS. The tRTS or CTS can be transmitted to all subchannels except the guard bands. As shown in the Figure, CTS can be transmitted to one subchannel except the three guard bands. It is possible to perform the asynchronous transmission to a channel except the guard band based on a basic channel in an available bandwidth. That is, in link B, the asynchronous transmission is performed during sections of data and acknowledgement transmission of link A while maintaining the guard band. The basic channel may be set to the sub-channel furthest away from a channel of another link among sub-channels of two different links of the non-STR MLD.

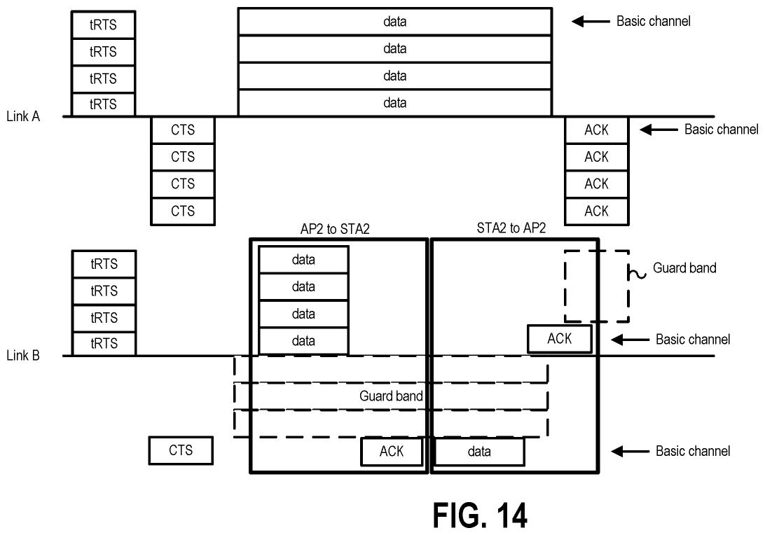

FIG. 14 is a diagram showing an uplink/downlink switching case for dynamic multi-link operations, in accordance with some embodiments of the present disclosure. As shown in the Figure, in link B, when AP2 sends data to STA2, AP2 uses full bands to send downlink data, and STA2 sends uplink ACK frame through partial bands with guard band applied. For uplink data, STA2 sends data to AP2 through partial bands with guard band applied and AP2 may send ACK frame through partial bands with guard band information indicated by tRTS.

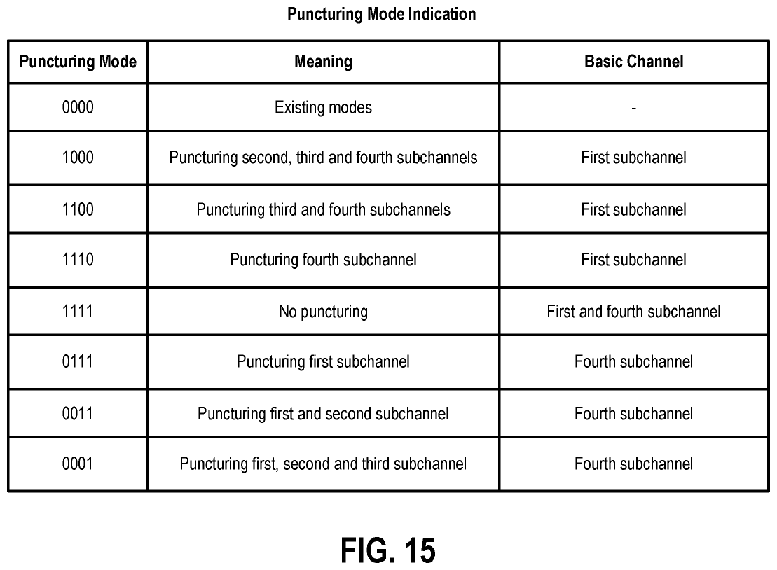

The guard band may be implemented as a preamble puncturing function introduced from an OFDMA manner to improve channel utilization of a wider bandwidth. FIG. 15 shows a table of puncturing mode indication, in accordance with some embodiments of the present disclosure. The table illustrates an example of indicating a puncturing mode as a bitmap. The puncturing pattern may be included in an EHT-SIG field, a management frame, or a triggering frame. For example, in the second row of the table, puncturing mode “1000” indicates puncturing of second, third, and fourth sub-channels. The other rows in the table may be interpreted in a similar manner.

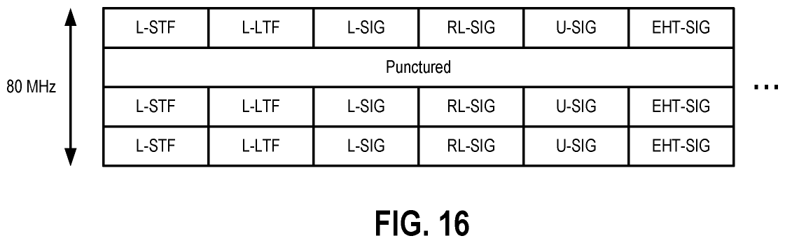

FIG. 16 is a diagram showing transmission of EHT-SIG including puncturing pattern, in accordance with some embodiments of the present disclosure. At the time of transmission at 80 MHz bandwidth, if the puncturing pattern is “1011”, the transmission may be performed as shown in the Figure. That is, a “1” in the puncturing pattern indicates that the corresponding signal is transmitted (not punctured), and a “0” in the puncturing pattern indicates that the corresponding signal is punctured. EHT-SIG may be transmitted after being duplicated as shown in the Figure.

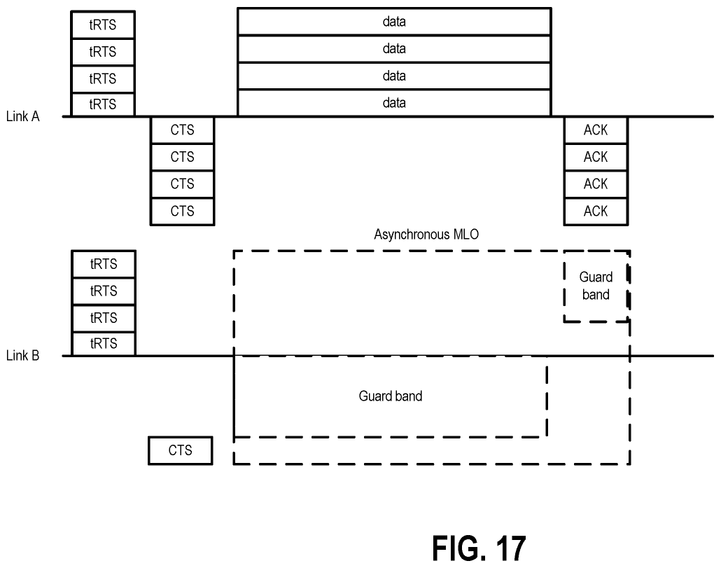

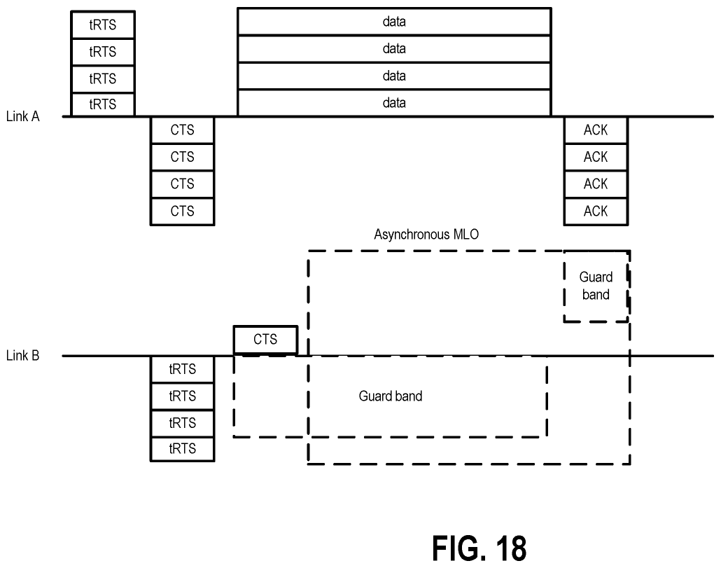

FIG. 17 and FIG. 18 are diagrams showing examples of TX/RX switching transmission in dynamic multi-link operations, in accordance with some embodiments of the present disclosure. According to some embodiments, during sections of transmission of data in link A, the transmission can be performed while performing TX/RX switching in link B. With this approach, flexible and efficient transmission may be performed in link B compared with synchronous transmission. When RTS/CTS is transmitted for sending data in link A, two methods of reserving asynchronous dynamic MLO of link B are available as shown in FIG. 17 and FIG. 18, respectively.

In FIG. 17, a case of simultaneously transmitting tRTS in multiple links for dynamic MLO is shown. As shown in the Figure, RTS/CTS is transmitted in link B simultaneously with RTS/CTS in link A. At this time, link B may indicate information for the asynchronous dynamic MLO via tRTS. In FIG. 18, tRTS in link B is transmitted in the same direction (uplink/downlink) at the time of CTS transmission after tRTS transmission, and the asynchronous dynamic MLO is reserved.

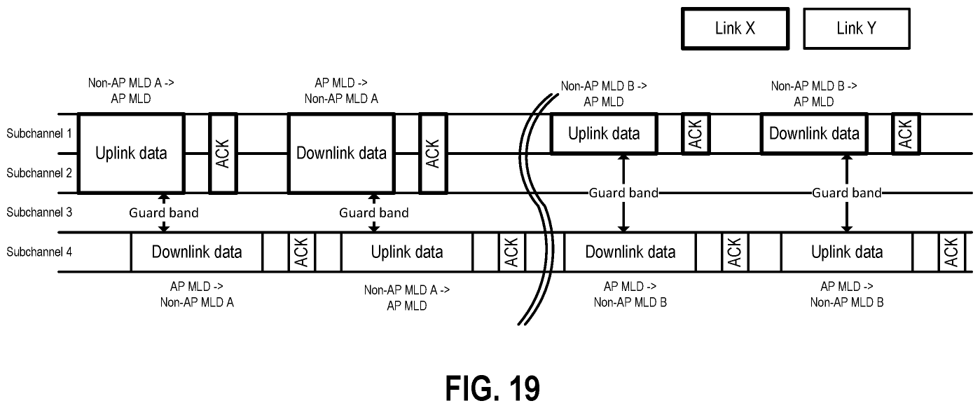

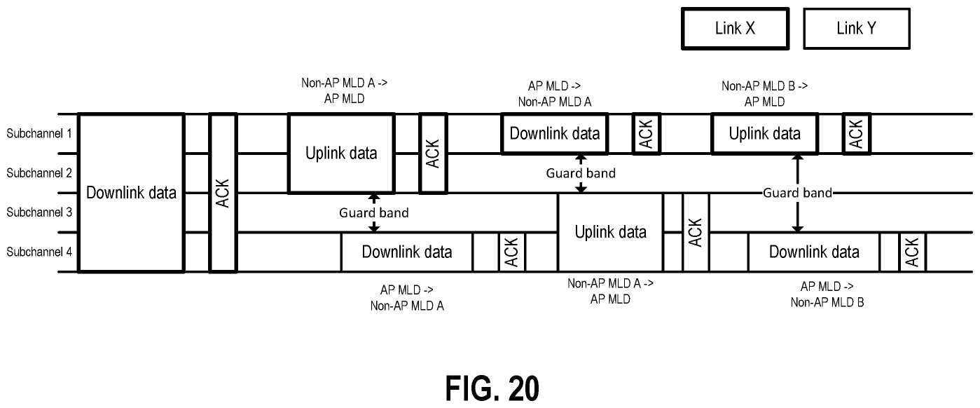

FIGS. 19 and 20 are diagrams showing static MLO and dynamic MLO, respectively, in accordance with some embodiments of the present disclosure. The static MLO may operate based on a value (guard band) determined during the link setup process, and the dynamic MLO may operate based on changing a value (guard band) on a frame-by-frame basis. An AP MLD (having a STR link set) may adjust the guard band of non-AP MLDs (having non-STR link set) during a link setup stage or under normal operation (after the link setup stage). For example, if the guard band is one sub-channel and two sub-channels respectively for non-AP MLD A and non-AP MLD B, transmission may be performed according to guard band conditions of non-AP MLD A and non-AP MLD B when asynchronously performing transmission by using multi-links. For this, an available channel of the non-AP MLD may be limited by indicating the guard band information and the dynamic MLO information using information elements of a management frame. The transmission may be performed by satisfying guard band requirements based on a basic channel of wireless link X and wireless link Y (referred to herein simply as “link X” and “link Y”) as shown in FIG. 19 and FIG. 20. As used herein, the basic channel means a channel that is set as a standard for dynamic bandwidth expansion. For example, in link X, a transmission channel is expanded or reduced based on subchannel 1, and in link Y, the transmission channel is expanded or reduced based on subchannel 4. Successive transmission is performed satisfying the guard band requirements on the basis of the direction (uplink/downlink) preoccupied in terms of the non-STR link set.

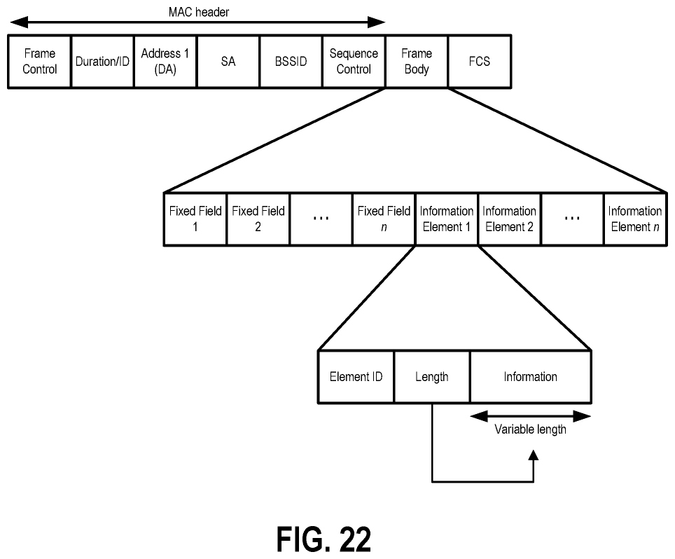

When the operation is conducted based on the value determined in the link setup process, the static MLO information may be indicated via a management frame (e.g., the management frame shown in FIG. 22), and in frame-unit operation, the dynamic MLO information may be indicated using a triggering type PPDU. At this time, the transmission bandwidth may be expanded or reduced on the basis of the basic channel of link X and link Y.

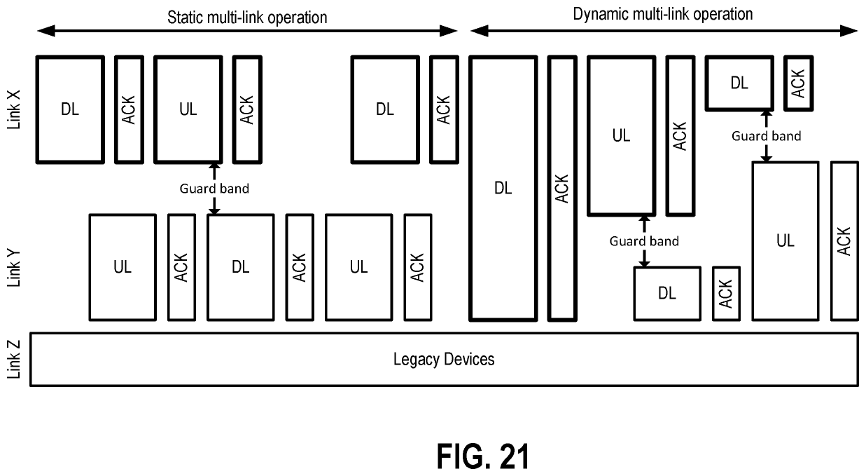

FIG. 21 is a diagram showing link allocation for multi-link operations, in accordance with some embodiments of the present disclosure. As shown in the Figure, the MLO mode can be changed between static MLO mode and dynamic MLO mode, and the link is configured to separate EHT devices from legacy devices, thereby providing efficient MLO operation.

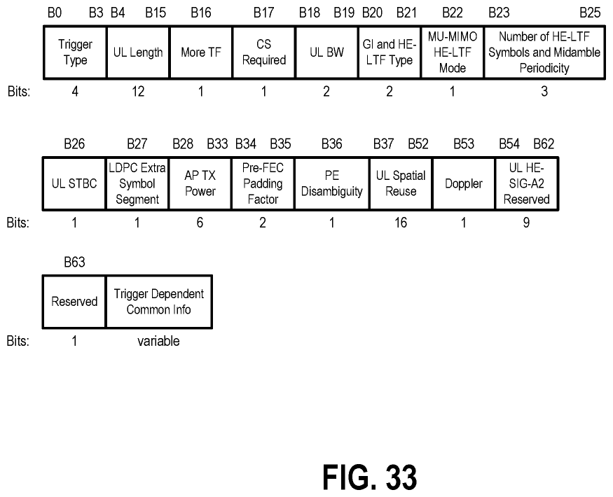

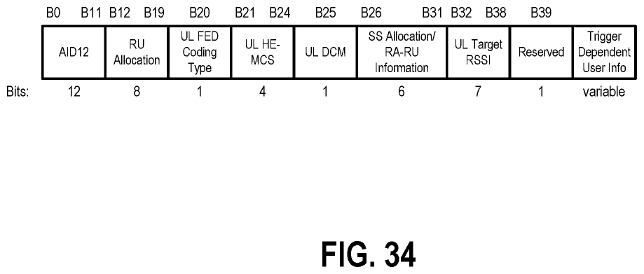

The dynamic MLO (DMLO) information may be included in a user info list (e.g., as shown in FIG. 34) or a common info list (e.g., as shown in FIG. 33) of a triggering type RTS. The dynamic MLO information may include at least one of: puncturing pattern information, basic channel information, bandwidth information, and guard band information. A DMLO mode may be indicated using a reserved bit, and the guard band information or DMLO information may be indicated using trigger dependent user info. For example, a MLO mode indication may include an indication of normal MLO (represented by binary “00”), static MLO (represented by binary “01”), or dynamic MLO (represented by binary “10”), and an RTS/CTS transmission method may be indicated. Normal MLO means a MLO mode of operating without a guard band.

FIG. 22 is a diagram showing a management frame for static multi-link operation, in accordance with some embodiments of the present disclosure. As shown in the Figure, the management frame includes a frame control field, a duration/ID field, an address 1 (DA) field, a SA field, a BSSID field, a sequence control field, a frame body field, and a FCS field. The frame body field may include fixed fields 1-n and information elements 1-n. An information element may include an element ID field, a length field, and an information field (where the value of the length field indicates the length of the information field).

An advantage of embodiments disclosed herein is that they help resolve the problem of uplink/downlink interference between multiple links that can occur when data is transmitted in one link while data is being simultaneously transmitted in another link through multi-link operations. Resolving this interference problem helps improve throughput and latency in the wireless network.

When an AP MLD with a simultaneous transmit and receive (STR) link set and a non-AP MLD with a non-STR link set send and receive data through an asynchronous transmission method, the interlink interferences cause performance degradation if uplink and downlink transmissions are performed simultaneously on two separate links at the non-AP non-STR MLD. This may result in a blindness problem at the non-AP non-STR MLD. In addition, if the non-AP non-STR MLD has a relationship with another non-AP MLD, the network environment has a possibility of encountering a hidden node problem. As a result, link and channel utilization efficiency is deteriorated.

An approach is described herein to solve such blindness and hidden node problems. As will be described in further detail below, the problem may be solved using one or more of the following five techniques: 1) padding, 2) LP (link protection) signaling, 3) TX priority, 4) subchannel signaling, and 5) multi-link RTS/CTS.

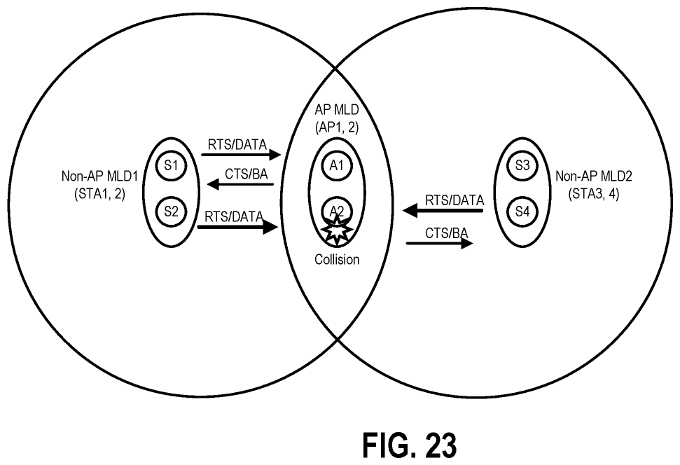

FIG. 23 is a diagram showing a wireless network environment in which a hidden node problem may occur, in accordance with some embodiments of the present disclosure. The wireless network environment shown in the Figure is one where two non-AP MLDs (non-AP MLD1 (implementing STA1 and STA2)) and non-AP MLD2 (implementing STA3 and STA4)) are associated with an AP MLD (implementing AP1 and AP2), and the non-AP MLDs have a non-STR link set. Although non-AP MLD1 and non-AP MLD2 are present within the signal transmission distance of the AP MLD, the range between the non-AP MLDs is outside the transmission distance of each other, hence the wireless network environment has a possibility of encountering a hidden node problem (and thus a collision may occur).

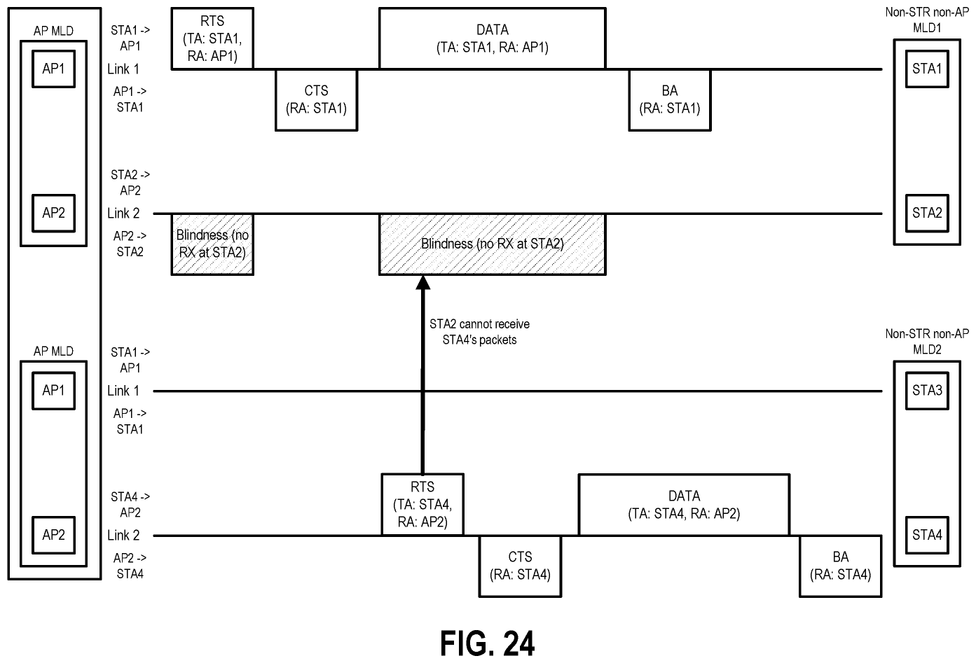

FIG. 24 is a diagram showing a blindness problem in the form of a packet transmission/reception flowchart, in accordance with some embodiments of the present disclosure. In the Figure, the AP MLD is shown two times (in the left side of the Figure) to represent the packet transmission/reception flowchart corresponding to non-AP MLDs 1 and 2, respectively, but both denote the same AP MLD. As shown in the Figure, STA1 of non-STR non-AP MLD1 transmits RTS to AP1 via link 1, and DATA and Block Ack (BA) are exchanged after receiving CTS. In the packet exchange process, STA2 of the non-AP MLD1 is in a blindness state where reception is impossible while STA1 transmits RTS and DATA in link 1. As used herein, a blindness problem means a state in which reception is not possible because the uplink and downlink transmissions cannot be performed simultaneously via multiple links in the non-STR MLD.

When STA2 is in the blindness state, if non-AP MLD2 transmits a packet using link 2, the preamble cannot be detected in addition to being unable to receive the packet. The blindness problem may cause the hidden node problem of not protecting transmission of another MLD.

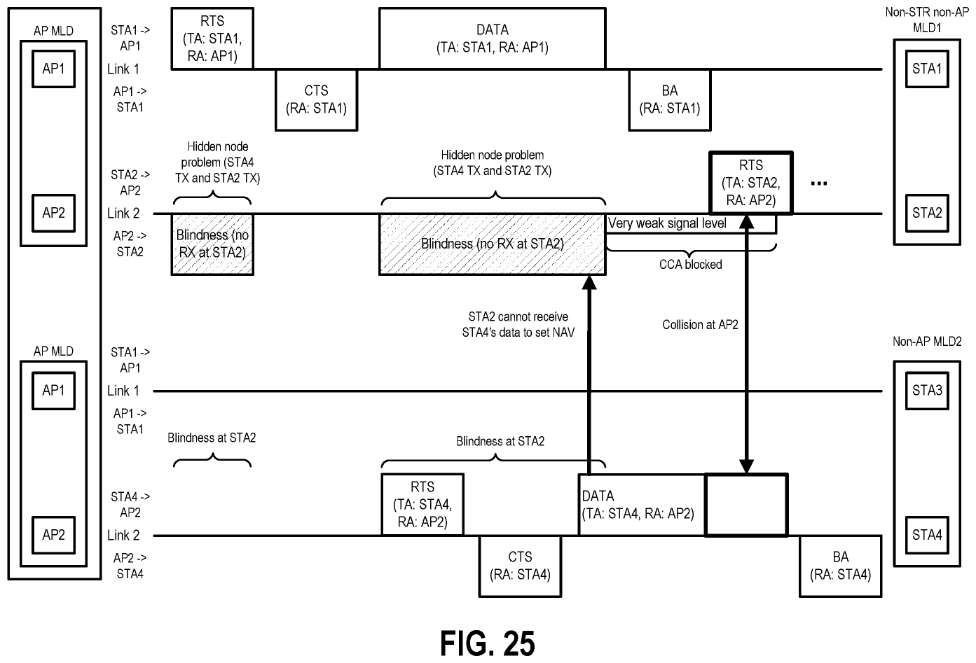

FIG. 25 is a diagram showing a case of encountering a combination of both the blindness problem and the hidden node problem, in accordance with some embodiments of the present disclosure. The Figure illustrates a situation where virtual carrier sensing cannot be conducted (e.g., by STA2) because the preamble is not detected due to the blindness problem. Since the non-AP MLDs are disposed at locations where the hidden node problem may occur, CCA (clear channel assessment) may be blocked due to a very weak signal strength. In this case, STA2 may transmit a packet (RTS) without recognizing that STA4 is transmitting a packet. When STA2 and STA4 simultaneously transmit packets, a collision occurs at AP2.

The problem can be solved using one or more of the following five techniques: (1) padding; (2) LP signaling; (3) TX priority; (4) subchannel signaling; and (5) multi-link RTS/CTS. Each of these techniques is further described herein below.

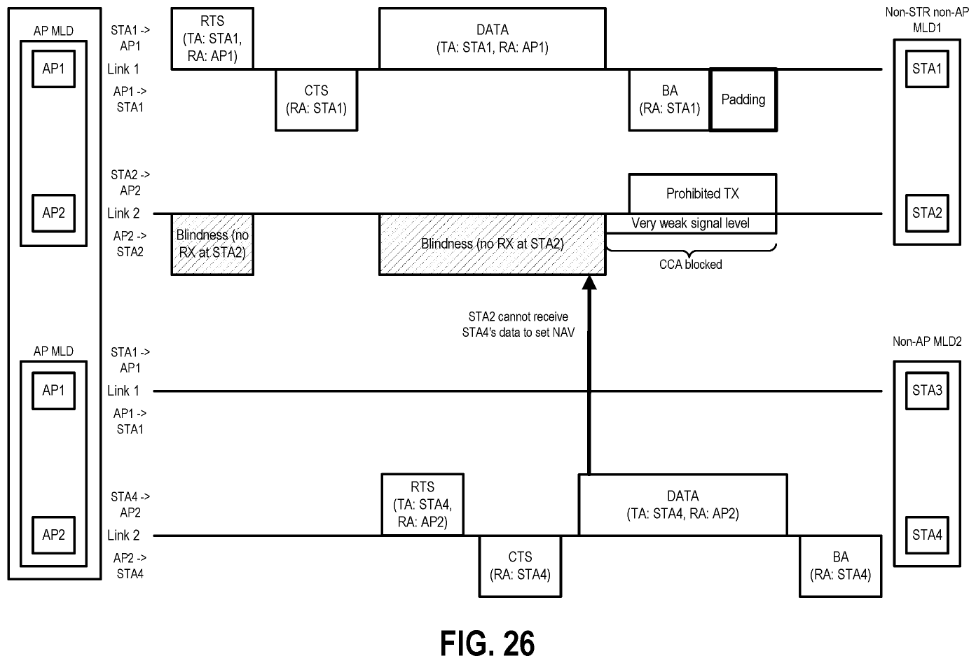

FIG. 26 is a diagram showing a block acknowledgement transmission method using padding, in accordance with some embodiments of the present disclosure. Since AP1 of the AP MLD knows the data transmission time of when STA4 transmits DATA to AP2 on link 2 (e.g., based on a length field in the preamble to figure out the length of DATA PPDU), the BA (block acknowledgement) transmission may be performed by attaching the padding until data transmission of STA4 is finished, thus solving the problem caused by the CCA being blocked in STA2 of the non-STR non-AP MLD1.

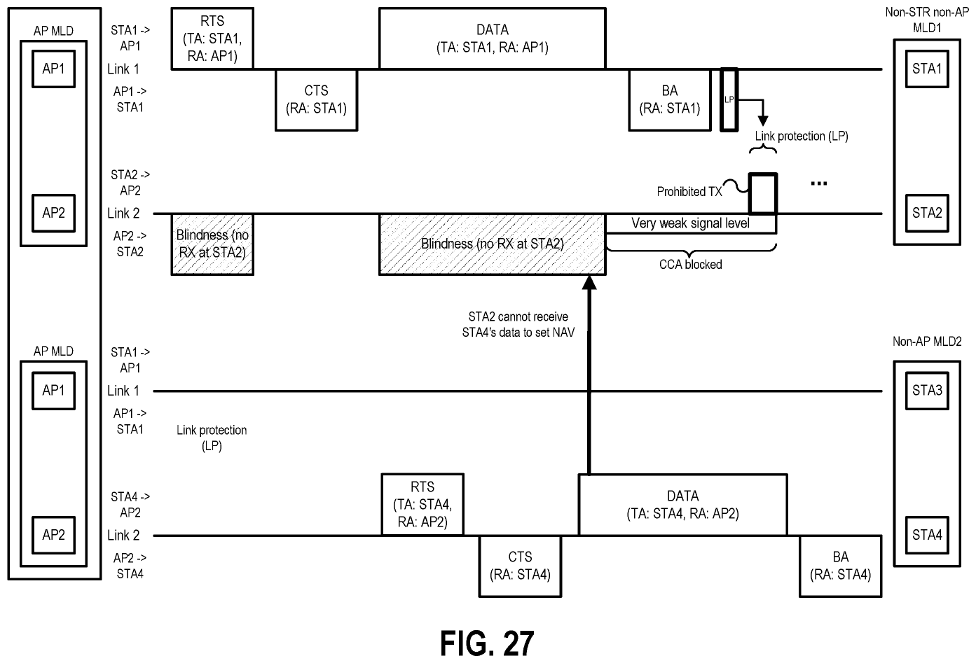

FIG. 27 is a diagram showing a link protection signaling method wherein interframe space between block acknowledgement and link protection may be a short interframe spacing, in accordance with some embodiments of the present disclosure. As shown in the Figure, link protection (LP) may include time information of prohibiting the transmission of STA2. STA1 shares LP with STA2 of non-STR non-AP MLPI to prevent STA2 from transmitting in the CCA-blocked section. The LP signaling method may use a CTS-to-self packet or define a new LP packet. A CTS-to-self or the new LP packet may include link protection section information, and the time may be set to time of closing the CCA-blocked section (time of when STA4 finishes data transmission).

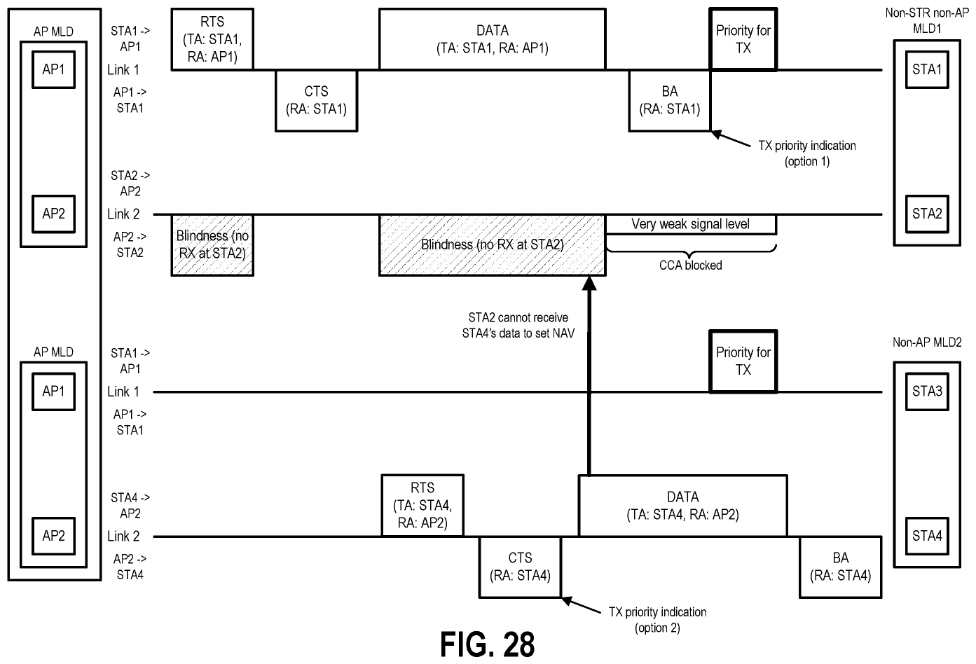

FIG. 28 is a diagram showing a transmission priority indication method, in accordance with some embodiments of the present disclosure. The method provides a transmission priority to other terminals except STA2 that may generate the collision problem with STA4 that is being currently transmitting in the CCA-blocked section (e.g., as shown in the Figure, STA1 or STA3 may be given priority). The TX priority indication method may include TX priority indication in an acknowledgement or a block acknowledgement (option 1 in the Figure) or include TX priority indication in RTS or CTS (option 2 in the Figure). In addition, this may be included in the newly defined packet and be transmitted. This may include terminal information or a transmission direction (an uplink or downlink) of providing the TX priority, and include transmission time information that can be transmitted using the TX priority.

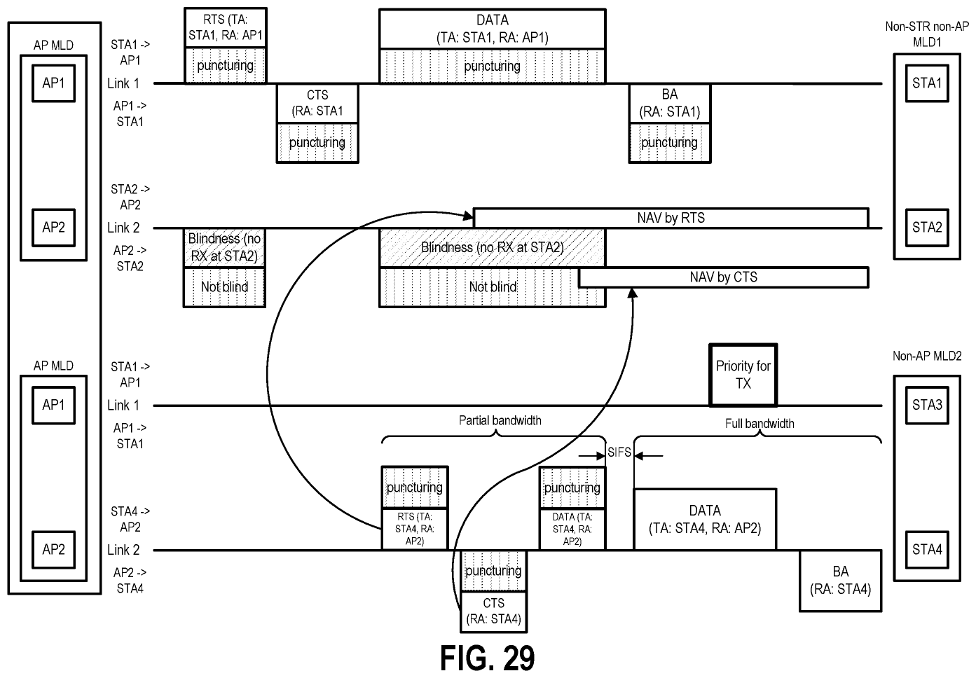

FIG. 29 is a diagram showing a subchannel signaling method, in accordance with some embodiments of the present disclosure. As shown in the Figure, in link 1, a partial subchannel is punctured for protection signaling in order to avoid a full blindness in a multi-link operation. In link 2, RTS/CTS is transmitted to the punctured subchannel before transmitting data, and if the protection section is ended after transmitting data, data may be transmitted at full bandwidth (without puncturing). As shown in the Figure, STA1 of non-AP MLD1 punctures partial subchannels (called a first subchannel) and transmits the packet over the rest of the partial subchannels (called a second subchannel) in link 1, and the punctured subchannel (the first subchannel) index is shared with the non-STR MLD. When non-AP MLD1 and AP MLD exchange RTS/CTS, the punctured subchannel index is indicated to non-AP MLD2 because non-AP MLD2 may receive either RTS or CTS. Since non-AP MLD2 may puncture the partial channel based on the information of the partial blindness subchannel (or the second subchannel) of STA2 and identify the subchannel that is not in the blindness state (the first subchannel), RTS and data of link 2 may be transmitted via the punctured subchannel (the first subchannel) of link 1. While the transmission may be finished while maintaining a partial bandwidth, as shown in the Figure, the transmission may also be performed at full bandwidth after the SIFS section once the blindness section ends.

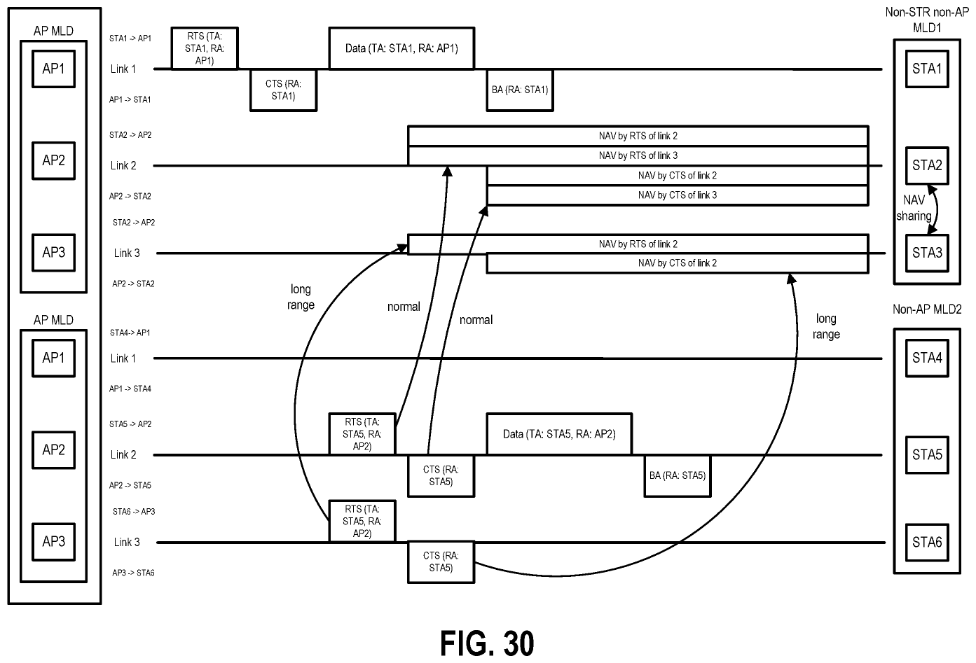

FIG. 30 is a diagram showing a method of transmitting normal RTS/CTS and long range RTS/CTS (a long-range RF or a newly defined ER mode) using multi-links, in accordance with some embodiments of the present disclosure. In the Figure, STA1 of non-STR non-AP MLD1 transmits RTS to AP1 via link 1, and DATA and block acknowledgement (BA) are exchanged after STA1 receives CTS. In the packet exchange process, STA2 of the non-AP MLD1 is in a blindness state where reception is impossible in link 2 while STA1 transmits RTS and DATA in link 1. When STA2 is in the blindness state, if non-AP MLD2 transmits a packet to link 2, preamble cannot be detected in addition to being unable to receive the packet. The blindness problem may cause the hidden node problem of not protecting transmission of another MLD because the received signal level is very weak. While the link (e.g., link 1 or link 2 in the Figure) used to transmit the data/ACK transmits the normal RTS/CTS, RTS/CTS may be transmitted in a long-range radio or extended range (ER) mode via another link (e.g., link 3 in the Figure) in order to avoid the hidden node problem. As a result, the normal RTS/CTS in link 2 supports compatibility with legacy devices, and the long-range mode RTS/CTS extends the range. Then STA3 may share the NAV information with STA2 (shown as “NAV sharing” in the Figure), and STA2 may protect the other STA's transmission.

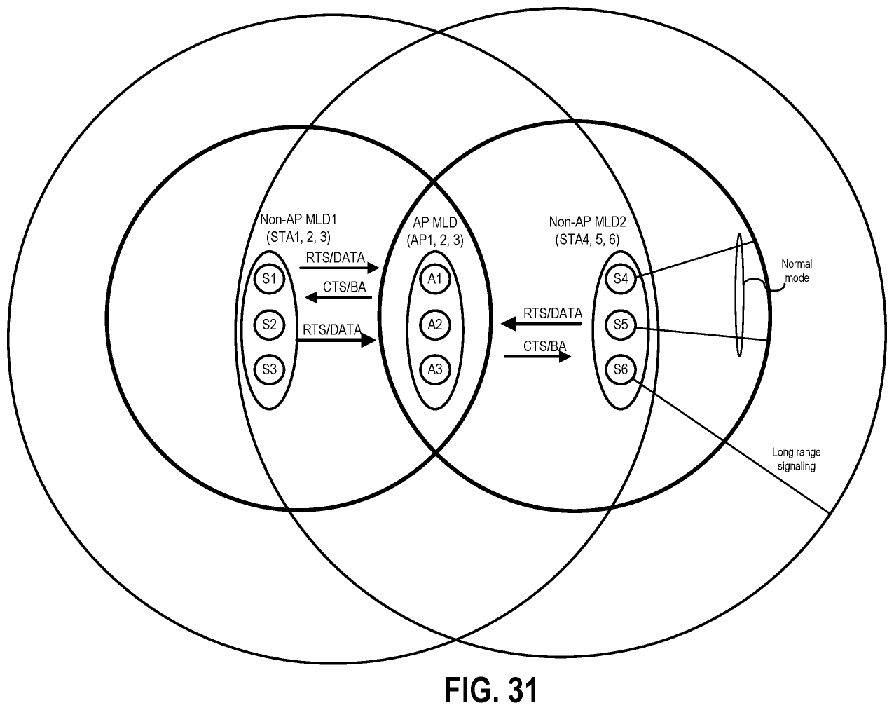

FIG. 31 is a diagram showing a wireless network environment with different signaling ranges, in accordance with some embodiments of the present disclosure. Each link of a multi-link setup may have different characteristics. For example, as shown in the Figure, STA6 (S6) may have a longer signaling transmission distance (or signaling range) than STA4 (S4) and STA5 (S5). Signal transmission distance characteristics may be utilized in accordance with radio frequencies, and a normal mode or extended range (ER) transmission method may be used.

For subchannel signaling method, the MLO information may be included in a common info list or user info list of the triggering type RTS. The MLO information may include at least one of puncturing pattern information, TX prohibition time information, TX priority information, NAV information, partial bandwidth information, and full bandwidth information.

An advantage of embodiments disclosed herein is that they effectively resolve the blindness and hidden node problem with uplink/downlink interference between multiple links that can occur when data is transmitted in one link while data is being simultaneously transmitted in another link through multi-link operations. Resolving these problems help improve throughput and latency in the wireless network.

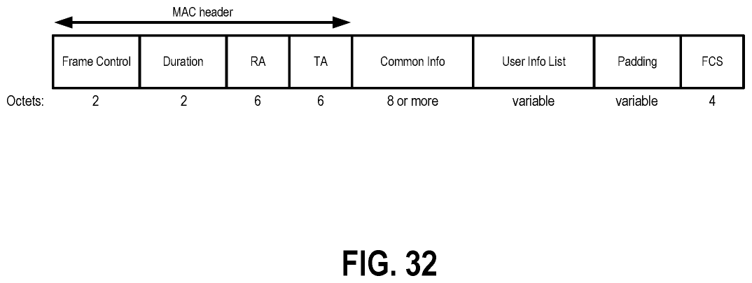

FIG. 32 is a diagram showing a trigger frame format, in accordance with some embodiments of the present disclosure. As shown in the Figure, the trigger frame format includes a frame control field (2 octets), a duration field (2 octets), a RA field (6 octets), a TA field (6 octets), a common info field (8 or more octets), a user info list field (variable size), a padding field (variable size), and a FCS field (4 octets). The frame control field, duration field, RA field, and TA field may form the MAC header.

FIG. 33 is a diagram showing a common info field format, in accordance with some embodiments of the present disclosure. As shown in the Figure, the common info field format includes a trigger type field (bits B0-B3), a UL length field (bits B4-B15), a more TF field (bit B16), a CS required field (bit B17), a UL BW field (bits B18-B19), a GI and HE-LTF type field (bits B20-B21), a MU-MIMO HE-LTF mode field (bit B22), a number of HE-LTF symbols and mid-amble periodicity field (bits B23-B25), a UL STBC field (bit B26), a LDPC extra symbol segment field (bit B27), a AP TX power field (bits B28-B33), a pre-FEC padding factor field (bits B34-B35), a PE disambiguity field (bit B36), a UL spatial reuse field (bits B37-B52), a doppler field (bit B53), a UL HE-SIG-A2 reserved field (bits B54-B62), a reserved field (bit B63), and a trigger dependent common info field (variable length).

FIG. 34 is a diagram showing a user info field format, in accordance with some embodiments of the present disclosure. As shown in the Figure, the user info field format includes a AID12 field (bits B0-B11), a RU allocation field (bits B12-B19), a UL FEC coding type field (bit B20), a UL HE-MCS field (bits B21-B24), a UL DCM field (bit B25), a SS allocation/RA-RU information field (bits B26-B31), a UL target RSSI field (bits B32-B38), a reserved field (bit B39), and a trigger dependent user info field (variable length).

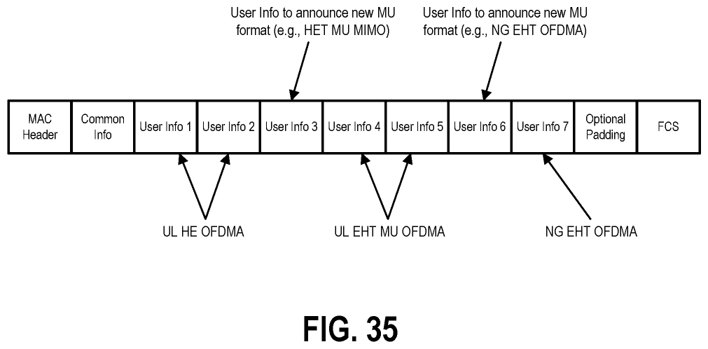

In one embodiment, a user info field with specific AID value in the AID12 field may be used to announce a specific PPDU format (e.g., one of HE/EHT/future TB (OFDMA or MU MIMO) PPDU formats and SU PPDU format). With it, other additional information can also be announced (e.g., the BW more than 160 MHz and 20 MHz Channel Bitmap that announce available 20 MHz channel for puncture operation). The user info fields may use the announced specific OFDMA (MU MIMO) format until a new OFDMA (MU MIMO) format is announced as shown in FIG. 35. FIG. 35 shows another user info field format, in accordance with some embodiments of the present disclosure. The user info field format includes a MAC header, a common info field, multiple user info fields (user info fields 1-7), optional padding, and a FCS field. The HE OFDMA format may be announced explicitly or may be announced by default (e.g., the user info fields immediately following the common user info field without OFDMA format announcement).

The UL HE SIG-A2 reserved field (e.g., shown in FIG. 33) may be redefined to carry the common information. A user info field with specific AID value in AID12 field may announce the common information. The common information may be divided into two group: TB (trigger-based) type independent common information and TB type dependent common information.

The TB type independent common information may include UL length, More TF, CS required, UL BW AP Tx power, and/or UL spatial reuse. Other additional information may include TB type and channel bitmap that announces available 20 MHz channel for puncture operation.

The UL HE SIG-A2 reserved field may be redefined to carry the information for EHT STAs and the STAs of next generation (NG) of EHT (EHT-NG STAs). The UL HE SIG-A2 indicates the redesigned B54 to B62 of the common info field (e.g., one bit (for example B54 as further common info indication field) is always set to 0 for such purpose). The further common info (B55 to B62) can indicate: the TB PPDU type or the Additional BW Indication.

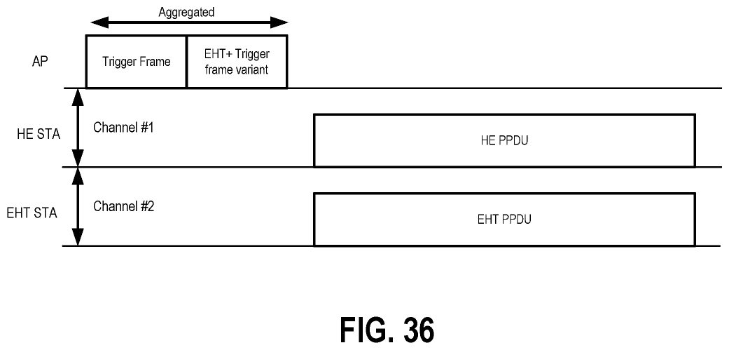

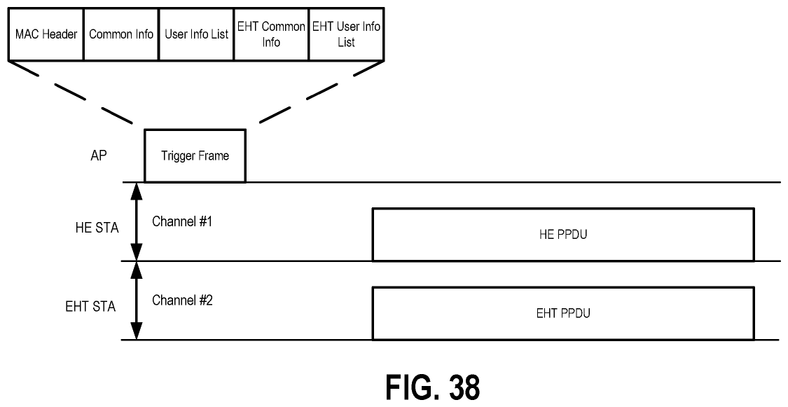

FIG. 36 is a diagram showing an aggregated trigger frame, in accordance with some embodiments of the present disclosure. Trigger frames may be used for HE, EHT and future 802.11 generations. The HE and EHT may be aggregated and transmitted to trigger on a single PPDU frame at the same time as shown in FIG. 38.

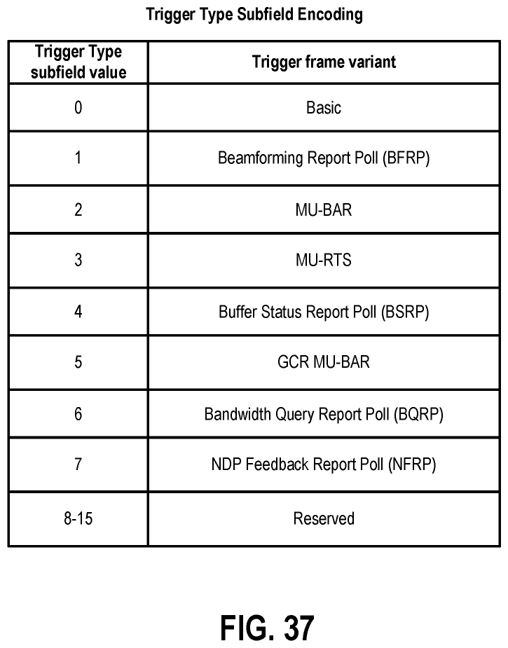

FIG. 37 is a table showing trigger type subfield encoding, in accordance with some embodiments of the present disclosure. Trigger type subfield may be a 4-bit subfield in the trigger frame. The MSB (most significant bit) of trigger type subfield may be reserved. In order to indicate a new triggering frame, MSB 1 bit as an indication can be used as follows: 0 indicates HE basic, 1 indicates EHT+basic. Bits 9-15 may be used to define a subtype.

FIG. 38 is a diagram showing a single trigger frame, in accordance with some embodiments of the present disclosure. As shown in the Figure, the single trigger frame includes a MAC header, a common info field, a user info list field, a EHT common info field, and a EHT user info list field.

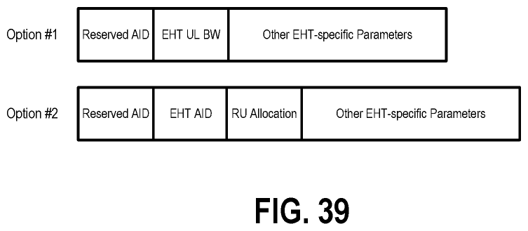

FIG. 39 is a diagram showing two options for the single trigger frame, in accordance with some embodiments of the present disclosure. In option 1, one of the reserved AID values (e.g. 2008-2044) is assigned for “EHT common info”. EHT STAs may recognize the user info field with the reserved AID where EHT STAs obtain EHT-specific common information from it while HE STAs ignore it. In option 2, an (EHT) AID field is added to specify EHT STA. RU allocation field may include multi-RU feature.

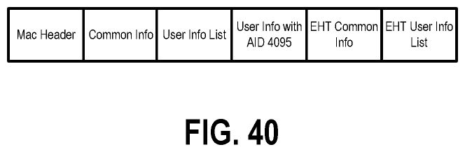

FIG. 40 is a diagram showing a trigger frame with AID 4095, in accordance with some embodiments of the present disclosure. The trigger frame includes a MAC header, a common info field, a user info list, a user info with AID 4095, an EHT common info field, and EHT user info list. In one embodiment, for a method for advanced trigger frame in 802.11be containing one user info field with AID 4095, HE STAs will not decode after AID 4095 because HE STAs interpret the following user info fields as padding fields while EHT STA shall decode after AID 4095, since all EHT specific information will be followed after it.

While certain frame/field formats are shown in the Figures and described herein, it should be understood that these are provided as an illustrative example and that other embodiments may use different frame formats to convey the same/similar information.

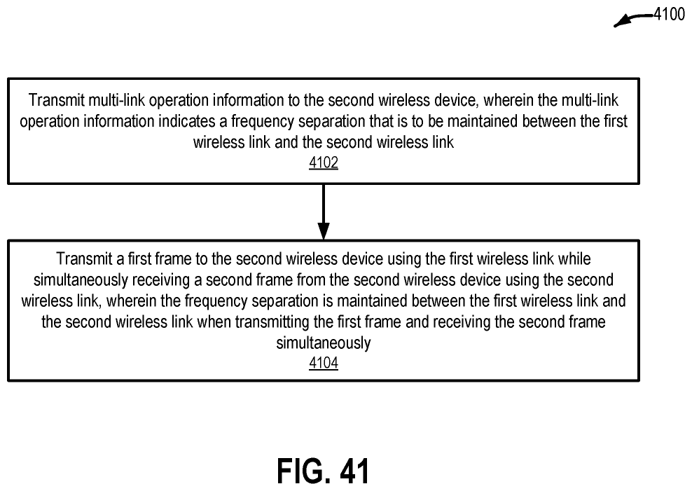

Turning now to FIG. 41, a method 4100 will now be described for supporting simultaneous transmit-receive in a wireless network, in accordance with some embodiment of the present disclosure. The method 4100 may be performed by one or more devices described herein. For example, the method 4100 may be performed by a first wireless device 104 in a wireless network to support simultaneous transmit-receive with a second wireless device in the wireless network using a first wireless link and a second wireless link.

Additionally, although shown in a particular order, in some embodiments the operations of the method 4100 (and the other methods shown in the other Figures) may be performed in a different order. For example, although the operations of the method 4100 are shown in a sequential order, some of the operations may be performed in partially or entirely overlapping time periods.

As shown in FIG. 41, the method 4100 may commence at operation 4102 with the first wireless device transmitting multi-link operation information to the second wireless device, wherein the multi-link operation information indicates a frequency separation that is to be maintained between the first wireless link and the second wireless link.

In one embodiment, the multilink operation information is included in a management frame. In one embodiment, the multilink operation information indicates the frequency separation as a subchannel puncturing pattern.

At operation 2004, the first wireless device transmits a first frame to the second wireless device using the first wireless link while simultaneously receiving a second frame from the second wireless device using the second wireless link, wherein the frequency separation is maintained between the first wireless link and the second wireless link when transmitting the first frame and receiving the second frame simultaneously.

In one embodiment, after transmitting the first frame to the second wireless device, the first wireless device transmit second multilink operation information to the second wireless device, wherein the second multilink operation information indicates a second frequency separation that is to be maintained between the first wireless link and the second wireless link that is different from the frequency separation used when transmitting the first frame and receiving the second frame simultaneously. The first wireless device then transmits a third frame to the second wireless device using the first wireless link while simultaneously receiving a fourth frame from the second wireless device using the second wireless link, wherein the second frequency separation is maintained between the first wireless link and the second wireless link when transmitting the third frame and receiving the fourth frame simultaneously. In this manner, the frequency separation may be changed dynamically (e.g., on a frame-by-frame basis).

In one embodiment, the second multilink operation information is included in a management frame. In one embodiment, the second multilink operation information is included in a control frame. In one embodiment, this control frame is a triggering type RTS frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for reducing interlink interference between an access point (AP) multi-link device (MLD) having a simultaneous transmit and receive (STR) link set and a non-AP MLD with a non-STR link set, comprising:
transmitting data, by the AP MLD, to the non-AP MLD on a first link;
simultaneously receiving data, by the AP MLD from the non-AP MLD, on a second link; and
aligning, by the AP MLD, an end time of transmitted physical layer protocol data units (PPDUs) using padding in response to concurrently transmitting another PPDU, by the non-AP MLD, on a link that is part of the non-STR link set.

2. The method of claim 1, wherein the AP MLD does not align the end time of transmitted physical layer protocol data units (PPDUs) and instead the method comprises:
prohibiting stations (STAs) affiliated with the non-AP MLD from transmitting on links of the non-STR link set for a time period based on a time required for virtual carrier sensing to be conducted by the STAs of the non-AP MLD and a timing duration carried in multi-link operation information.

3. The method of claim 2, wherein the multi-link operation information is included in a management frame.

4. The method of claim 1, wherein the PPDU aligned by the AP MLD includes a block acknowledgement (BlockACK) frame.

5. The method of claim 1, wherein the PPDU transmitted by the non-AP MLD includes a length field in a preamble.

6. The method of claim 5, wherein the length field of the preamble indicates a length of a data subfield within the PPDU.

7. The method of claim 6, wherein padding performed by the AP MLD is based on the length field of the preamble.

8. An access point (AP) multi-link device (MLD) that has a simultaneous transmit and receive (STR) link set for reducing interlink interference between the AP MLD and a non-AP MLD with a non-STR link set, comprising:
a memory device storing a set of instructions; and
a processor coupled to the memory device, wherein the set of instructions when executed by the processor cause the station to:
transmit data, by the AP MLD, to the non-AP MLD on a first link;
simultaneously receive data, by the AP MLD, from the non-AP MLD, on a second link; and
align, by the AP MLD, an end time of transmitted physical layer protocol data units (PPDUs) using padding in response to concurrently transmitting another PPDU, by the non-AP MLD, on a link that is part of the non-STR link set.

9. The AP MLD of claim 8, wherein the AP MLD does not align the end time of transmitted physical layer protocol data units (PPDUs) and instead prohibits stations (STAs) affiliated with the non-AP MLD from transmitting on links of the non-STR link set for a time period based on a time required for virtual carrier sensing to be conducted by the STAs of the non-AP MLD and a timing duration carried in multi-link operation information.

10. The AP MLD of claim 9, wherein the multi-link operation information is included in a management frame.

11. The AP MLD of claim 8, wherein the PPDU aligned by the AP MLD includes a block acknowledgement (BlockACK) frame.

12. The AP MLD of claim 8, wherein the PPDU transmitted by the non-AP MLD includes a length field in a preamble.

13. The AP MLD of claim 12, wherein the length field of the preamble indicates a length of a data subfield within the PPDU.

14. The AP MLD of claim 13, wherein padding performed by the AP MLD is based on the length field of the preamble.

15. A non-transitory machine-readable storage medium storing instructions, which when executed by an access point (AP) multi-link device (MLD) having a simultaneous transmit and receive (STR) link set in a wireless network, causes the AP MLD to perform operations for reducing interlink interference by supporting simultaneous transmit-receive with a non-AP MLD with a non-STR link set, the operations comprising:
transmitting data, by the AP MLD, to the non-AP MLD on a first link;
simultaneously receiving data, by the AP MLD from the non-AP MLD, on a second link; and
aligning, by the AP MLD, an end time of transmitted physical layer protocol data units (PPDUs) using padding in response to concurrently transmitting another PPDU, by the non-AP MLD, on a link that is part of the non-STR link set.

16. The non-transitory machine-readable storage medium of claim 15, wherein the AP MLD does not align the end time of transmitted physical layer protocol data units (PPDUs) and instead the operations comprises:
prohibiting stations (STAs) affiliated with the non-AP MLD from transmitting on links of the non-STR link set for a time period based on a time required for virtual carrier sensing to be conducted by the STAs of the non-AP MLD and a timing duration carried in multi-link operation information.

17. The non-transitory machine-readable storage medium of claim 16, wherein the multi-link operation information is included in a management frame.

18. The non-transitory machine-readable storage medium of claim 15, wherein the PPDU aligned by the AP MLD includes a block acknowledgement (BlockACK) frame.

19. The non-transitory machine-readable storage medium of claim 15, wherein the PPDU transmitted by the non-AP MLD includes a length field in a preamble.

20. The non-transitory machine-readable storage medium of claim 19, wherein the length field of the preamble indicates a length of a data subfield within the PPDU.

21. The non-transitory machine-readable storage medium of claim 20, wherein padding performed by the AP MLD is based on the length field of the preamble.
